(19) United States
(12) Patent Application Publication
(10) Pub. No.: US 2011/0056577 A1
(43) Pub. Date: Mar. 10, 2011

(54) Rinse Assembly with Live Swivel Fitting

(76) Inventor: Gareth Ilett, Calgary (CA)

(21) Appl. No.: 12/529,765

(22) PCT Filed: Mar. 5, 2008
(86) PCT No.: PCT/CA2008/000435

§ 371 Date: Jul. 30, 2010

Related U.S. Application Data
(60) Provisional application No. 60/892,892, filed on Mar. 5, 2007.
(60) Provisional application No. 60/941,000, filed on May 31, 2007.

(51) Int. Cl. F16K 21/00; B23P 17/04

(52) U.S. Cl. 137/801; 29/401.1

(57) ABSTRACT

A rinse assembly for a commercial washdown pre-rinse system is described, including a flex hose and live swivel fitting. The incorporation of an infinitely rotatable swivel fitting at the base of the flex hose and/or adjacent the spray nozzle releases torsion within the flex hose and prevents damage to the hose and surrounding metal coil due to shear stress. A modular rinse assembly in which components may be easily added, removed, or replaced is described, as well as a method to retrofit existing rinse assemblies to incorporate a live swivel fitting.

### FIELD OF THE INVENTION

The present invention relates generally to commercial washdown systems. More particularly, the present invention relates to washdown pre-rinse systems incorporating a live swivel fitting to increase the life of various system components.

### BACKGROUND OF THE INVENTION

Conventional rinsing assemblies generally include a vertical riser extending from a tap at a water source, a flexible hose attached to the riser, and a spray nozzle at the opposite end of the hose. Such systems are typically used in health and food-related settings to clean equipment or dishes and utensils. Due to the strict health guidelines and regular inspections imposed on operators of these systems, all components must be maintained in good working order, as damaged or worn surfaces may collect contaminating dirt and bacteria, or may injure employees during operation.

In these rinse assemblies, a spray nozzle generally hangs from a flexible hose, which provides the required degree of manipulation by the user within the washing/rinsing area. A main shutoff or tap is extended by attachment of a vertical riser to a useful height, for example to approximately counter or sink height. A riser adapter coupling is usually threaded to the vertical riser, the riser adapter coupling having an enlarged lower rim, or hex portion. A flexible hose is provided, with a metal fitting crimped over one end. The metal fitting is threaded for attachment above the riser adapter coupling, thereby securing the flexible hose to the water source.

To add rigidity to the otherwise soft flex hose, a steel coiled sleeve is placed around the flex hose above the vertical riser pipe. Further, a large ring coil slides freely over the flex hose to the base of the washdown system, resting on the enlarged lower rim of the riser adapter.

During use, the rigid steel sleeve and hose are subject to repeated torsion and resulting shear stress as the user pulls, twists, and otherwise manipulates the spray nozzle. This torsion is maintained until the user releases the spray nozzle, at which time the torsion is relieved to some degree. Over time, repeated application and release of torsion within the flex hose during normal commercial use will result in weakening and deformation of the hose and steel sleeve until the steel sleeve shears, leaving sharp, jagged edges. As the user manipulates the now damaged steel coil sleeve and flex hose, the jagged edges of the steel coil sleeve repeatedly pierce the soft inner flex hose. Within a short period of time, the hose becomes permanently damaged and can no longer support water. In order to return the system to working order, the entire flex hose must be replaced.

Moreover, a typical repair involves replacement of the entire rinse assembly, as rinse assemblies are generally provided as a unit with threadings that are atypical such that compatible replacement components are not readily available in the trade.

It is, therefore, desirable to provide a rinse assembly that will withstand repeated commercial use, and in which individual parts may easily be replaced as necessary.

### SUMMARY OF THE INVENTION

It is an object of the present invention to obviate or mitigate at least one disadvantage of previous washdown pre-rinse systems.

In a first aspect, the present invention provides a rinse assembly for use in commercial washdown systems, the rinse assembly comprising: a length of flexible hose having first and second ends, the first hose end operatively attachable to a valve base associated with a fluid source, the second end for handling and manipulation by a user in rinsing items; and a live swivel fitting operatively attachable to the first or second end of the flex hose for limiting torsion within the flex hose during use.

In an embodiment, the live swivel fitting is threadably attached between the first end of the flex hose and the valve base for relieving torsion within the flex hose during use. A second live swivel fitting may be threadably attached between the second end of the flex hose and a spray nozzle for preventing application of torsion to the flex hose during manipulation of the spray nozzle.

In another embodiment, the live swivel fitting is threadably attached between the second end of the flex hose and a spray nozzle for preventing application of torsion to the flex hose during manipulation of the spray nozzle.

In an embodiment, the live swivel is rotatable through 360 degrees about the hose axis.

In another embodiment, the first and second ends of the flexible hose comprise a threaded fitting.

In a further embodiment, the live swivel fitting is attached to the first end of the flex hose by crimping a portion of the live swivel fitting over the first end of the flex hose.

In further aspect, the rinse assembly further comprises a spray nozzle assembly threadably attached to the second end of the flex hose for use in rinsing items with fluid from the fluid source.

In another embodiment, the valve base comprises a tap assembly and a vertical riser. The rinse assembly may be placed adjacent one or more wash stations and the second end of the flex hose may be used for rinsing items at said wash stations.

In certain embodiments, the flex hose may be a type suitable for use in high pressure applications and/or high temperature applications.

The rinse assembly may further comprise a ring coil for placement about the flex hose for support. The ring coil may extend over the live swivel fitting.

In a second aspect of the invention, there is provided a method for retrofitting a commercial rinse assembly to incorporate a live swivel fitting, the method comprising the steps of providing a live swivel fitting; and installing the live swivel fitting adjacent an existing component of the rinse assembly. The live swivel fitting may include suitable threaded ends for attachment to existing rinse assembly hardware.

The live swivel fitting may be produced by machining a standard male or female fitting to receive a bearing and a seal, to produce a live swivel inner portion having a threaded end and a swivel extension end; placing a bearing and a seal about the swivel extension end; and swaging a male fitting over the swivel extension end, the bearing, and the seal to produce a live swivel fitting.

In another embodiment, the live swivel fitting is of suitable diameter to receive a ring coil, and the live swivel is attached between a flex hose and a valve base of the rinse assembly.

In a further embodiment, the method comprises the steps of providing an adapter fitting for attachment between the live swivel fitting and existing rinse assembly hardware; and connecting the adapter fitting to the live swivel fitting.

In a specific embodiment, the live swivel is installed between a flex hose and a valve base of the rinse assembly. In another embodiment, the live swivel is installed between a flex hose and a spray nozzle of the rinse assembly.

In accordance with a third aspect of the invention, there is provided a modular rinse assembly in which components may be individually replaced with standard parts, the system comprising: a threaded live swivel fitting for threadable association with a flex hose; a threaded spray assembly for threadable association with a flex hose; and a flex hose bearing first and second threaded ends, wherein the threaded portion of each of the valve base, live swivel fitting, flex hose, and spray assembly are of standard pipe threading such that any damaged component may be individually replaced within the assembly by a standard threaded replacement component.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an exploded view of a rinse assembly in accordance with an embodiment of the invention;

FIG. 2A-D are schematic cross-sectional views of fittings shown in FIG. 1;

FIG. 3 is a schematic side view of a swivel fitting in accordance with an embodiment of the invention;

FIG. 4 is an exploded view of a rinse assembly in accordance with an embodiment of the invention;

FIG. 5 is an exploded view of a rinse assembly in accordance with an embodiment of the invention;

FIG. 6 is an exploded view of a rinse assembly in accordance with an embodiment of the invention;

FIG. 7 is a longitudinal cross section of a live swivel fitting in accordance with an embodiment of the invention; and

FIG. 8 is a longitudinal cross section of a live swivel fitting in accordance with an embodiment of the invention.

### DETAILED DESCRIPTION

Generally, the present invention provides a rinse assembly with reduced susceptibility to wear, and in which individual components may be replaced as necessary. Specifically, the rinse assembly of the present invention includes a live swivel fitting adjacent or otherwise threadably associated with a flex hose to relieve torsion within the flex hose during use. In most instances, placement of the live swivel between the flex hose and the vertical riser will be most useful, however, placement at other locations may also be advantageous in certain applications. For example, a live swivel may be placed between the flex hose and the nozzle either instead of or in addition to the aforementioned swivel position. Placement of a live swivel at this location will improve the user's ability to focus the spray nozzle quickly and accurately while minimizing the need to pull, rotate or otherwise manipulate the flex hose.

The system incorporates standard pipe threading at various locations such that individual components of the system may be easily replaced or upgraded as needed. A method for retrofitting existing rinse assemblies to incorporate a live swivel adjacent the flex hose is also described.

The rinse assembly of the present invention is intended for use in various settings, most suitably in commercial food, health, or other related settings such as telephone shower hoses associated with bathtubs. The system may also be incorporated within portable rinse assemblies such as pressure washers, fire hoses and the like. A rinse assembly in accordance with the invention will generally include a valve base, which may include a tap system and vertical riser pipe; a live swivel fitting continuous with the valve base to permit free axial rotation of an attached flex hose; and a spray assembly continuous with the opposing end of the flex hose.

As the system permits maximal manipulation of the flex hose while releasing shear stress within the hose, the rinsing assembly may be used over a large rinsing area without torsional binding of the hose. For example, one rinse apparatus may serve two back-to-back workstations. Although such an arrangement may burden the rinse assembly with near continuous usage, it is anticipated that the system will not require frequent replacement of the flex hose. Moreover, when replacement of the hose or spray nozzle becomes necessary, these components may be individually replaced with readily available threaded components as the threading within the rinse assembly is preferably standard pipe threading.

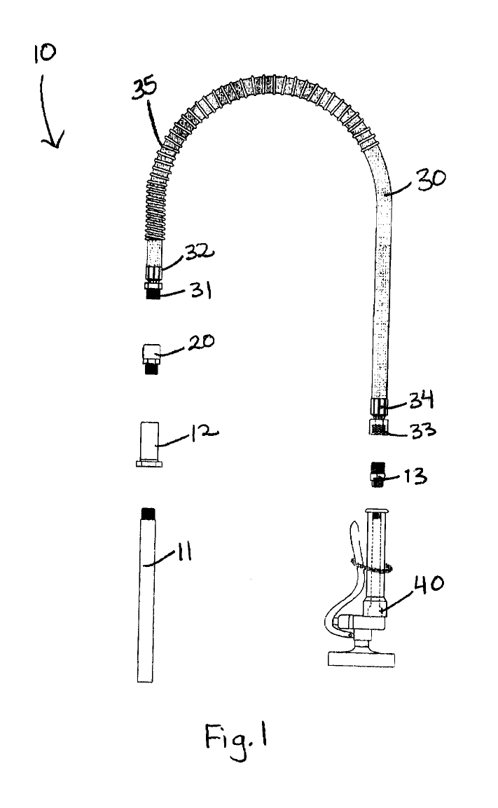

With reference to FIG. 1, a rinse assembly 10 in accordance with an embodiment of the invention is shown. The rinse assembly 10 includes a valve base having a vertical riser 11, riser adapter 12, swivel fitting 20, flex hose 30, and spray nozzle 40. The flex hose 30 bears threaded male end fitting 31 and threaded female end fitting 33, which are affixed to the flex hose 30 by crimping of metal sleeves 32, 34, respectively, over the ends of the hose.

The swivel fitting 20, is threaded to the male end fitting 31 of the flex hose 30, and is attached to the vertical riser pipe via custom riser coupling fitting 12. Likewise, the female end fitting 33 of the flex hose 30 is attached to nozzle 40 via threading engagement with adapter fitting 13.

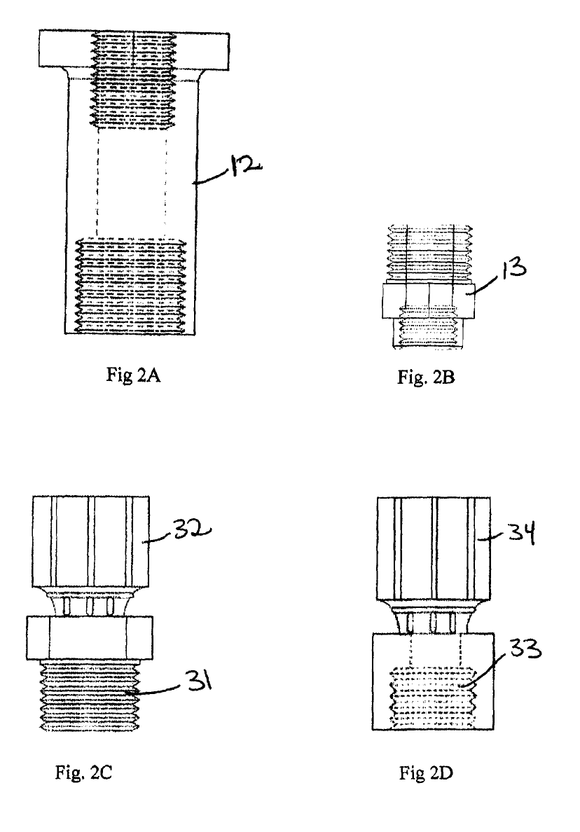

With reference to FIGS. 1, 2A and 2B, riser coupling fitting 12 and adapter fitting 13 have been customized to allow incorporation of the live swivel fitting and standard threaded components within the rinse assembly. Specifically, riser coupling fitting 12 (normally a male fitting in standard washdown systems) was modified to a femal standard thread in order to receive the male end of the live swivel fitting 20, and the riser coupling fitting 12 was also reduced in diameter in order to improve the clearance between the outer diameter of the fitting and the inner diameter of the ring coil 35. Adapter 13 is provided for attachment to the flex hose using standard pipe threading on one side, with threading on the opposing side suitable for connection to a spray nozzle.

Flex Hose

The flex hose 30 is a length of durable, flexible hose having threaded end fittings 31, 33. In a suitable embodiment for versatile use in commercial food and health related settings, the hose is capable of handling both low pressure and high pressure applications and withstanding temperatures up to 253 degrees Fahrenheit.

In suitable embodiments, the hose may be composed of modified nitrile, and may be reinforced with braided synthetic high tensile cord or cross-linked wire. However, various types of hoses suitable for use in the present system are readily available and are known to those of skill in the art.

The hose 30 shown in FIG. 1 bears threaded end fittings 31, 33. These fittings are also shown in FIGS. 2C and 2D, each bearing a crimpable portion 32, 34 for crimping over the outer surface of the hose 30 and a standard male or female threaded end. Alternatively, the flex hose may have two male threaded ends 31, 31, or two female ends, 33, 33 and the second end may be attached to a spray nozzle or other component through use of an adapter.

In order to satisfy regulatory requirements for use in commercial food and/or health settings, the thread exposures should be kept to a minimum, particularly with respect to the surface forming the inner diameter of the fitting, reducing the surface area and edges available to harbour foreign particles and bacteria.

A ring coil 35 may be placed around a portion of the hose 30 as shown in FIG. 1 to support the hose and prevent crimping of the hose during use. It is anticipated that the ring coil will not be subject to a great degree of torsion and shear stress as it slides easily over the flex hose to rest on the hex portion of the riser adapter 12, freely rotating about the flex hose, live swivel and additional fittings (if present). As a result, the hose 30 and ring coil 35 will rotate somewhat independently, and wear to the hose and coil will be minimized.

Valve Base

The valve base of the rinse assembly generally regulates fluid flow, pressure, or temperature from a fluid source. Typically, the fluid source will be water, which may have detergents or solvents dissolved therein to aid washing or rinsing of items in the associated sink or rinsing area. With reference to FIG. 1, the valve base will typically include a tap and vertical riser pipe 11, which may be assembled in any known configuration. In suitable embodiments, the protruding portion of the valve base to which the flex hose 30 is to be connected will be threaded with standard pipe thread known in the trade.

Live Swivel Fitting

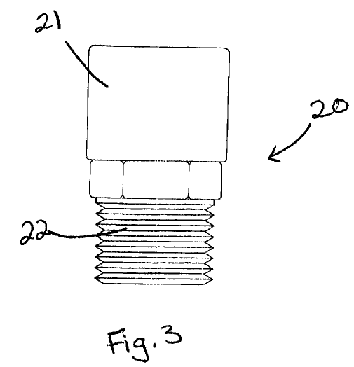

The live swivel fitting 20 for use in the rinse assembly is rotatable through 360 degrees with respect to the axis of the vertical riser and flex hose. In other words, the swivel fitting is infinitely rotatable in either direction, to maximally relieve torsion and shear stress within the hose 30 and ring coil 35. Therefore, as the user twists the spray nozzle 40, the flex hose 30 initially twists to cause torsion and shear stress within the hose. With reference to FIG. 3, when the torsion within the hose reaches the swivel fitting, the upper portion 21 of the swivel fitting will freely rotate with respect to the fixed portion 22 of the swivel fitting, which is secured within the adapter 12. As such, the torsion will be released at the swivel fitting 20 by the free rotation of the upper portion 21 of the swivel fitting with respect to the fixed portion 22.

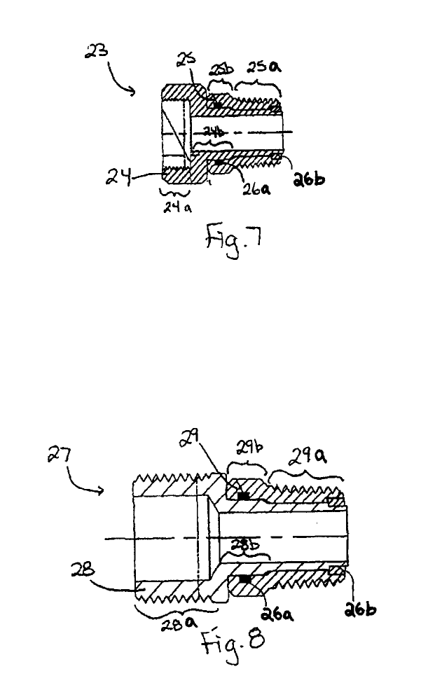

Live swivel fittings in general are known in the art and can be purchased from specialized suppliers for modification and application within the present system. The fitting should include standard threading and be of appropriate diameter to permit the ring coil 35 to slide over and rest on the riser coupling fitting 12. This will require modification of the wall thickness of the fitting, size and placement of seals, and shape of the fitting. For example, suitable customized live swivel fittings 23, 27, are shown in FIGS. 7 and 8.

With reference to FIG. 7, a male-female live swivel fitting 23 includes an inner portion 24 having threaded female end 24a and swivel extension 24b; and an outer portion 25, with threaded male end 25a and swivel extension 25b. The swivel extensions 24b, 25b house seal ring 26a and bearing ring 26b. The resulting swivel fitting 23 is therefore infinitely rotatable and watertight.

In FIG. 8, a male-male live swivel fitting 27 is shown. Inner portion 28 has a male threaded end 28a and swivel extension 28b, while outer portion 29 has a male threaded portion 29a and swivel extension 29b. The swivel extensions 28b, 29b house seal ring 26a and bearing 26b. The resulting swivel fitting 27 is therefore infinitely rotatable and watertight.

The fittings shown in FIGS. 7 and 8 were produced by machining a standard male or female fitting to create the inner portion with swivel extension. Grooves are machined at appropriate locations to accommodate the bearing ring and seal ring. A male fitting is then swaged over the swivel extension to create the outer portion of the live swivel fitting.

Live swivel fittings for use between the flex hose and the valve base may be machined to appropriate diameter to allow free sliding and rotating movement of a ring coil about the flex hose and live swivel fitting.

The customized live swivel fittings can be manufactured to any diameter or type of threading depending on the components to be connected on either side of the live swivel. Customized production and use of such fittings will minimize the number of adapter fittings that would otherwise be necessary (and may need to be custom manufactured) to assemble the presently described system.

In certain situations, the user may prefer to incorporate a readily available live swivel fitting using adapter fittings. These adapter fittings may be purchased or machined to desired specifications.

Spray Nozzle Assembly

The second end of the hose (the end not threaded to the swivel fitting) may be used to rinse items, or a spray assembly 40 may be attached thereto using an adapter fitting 13. The spray assembly may include a valve for adjusting the flow, pressure, or spray pattern.

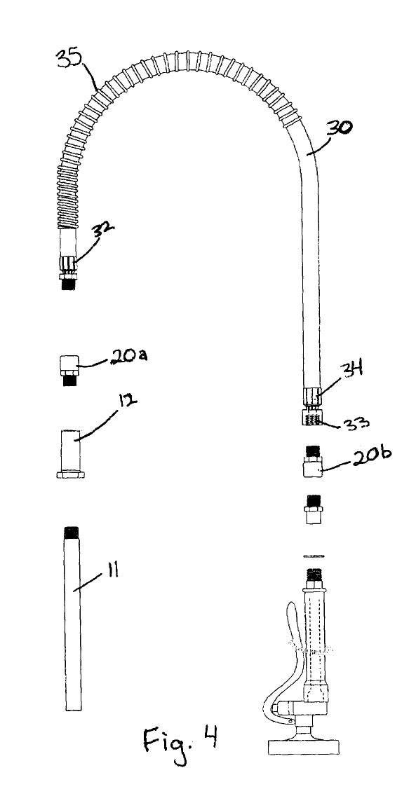

In certain applications it may be desirable to include another swivel fitting between the second end of the flex hose and the spray assembly to relieve torsion at the nozzle end of the flex hose, preventing accumulation of torsion in the flex hose. In such embodiment, as exemplified by the system shown in FIG. 4, appropriate adapters may be incorporated to accommodate the threading and desired location of the additional swivel fitting. Notably, the swivel fittings may be modified or designed to accommodate standard fittings and to allow direct connection of the swivel fitting to a male or female flex hose end.

Suitable customized fittings, for example a fitting resembling live swivel fitting 23 (FIG. 7), may be sized and threaded appropriately for mating with the spray assembly 40.

Modular Rinse Assembly

The rinse assembly described herein may be created by assembly or retrofitting. A modular rinse assembly allows any system component to be replaced with readily available trade-standard components. In this embodiment, the major components are all threadably attached using trade-recognized standard pipe threading, allowing the system to be customized, with individual components easily added, removed, or replaced. For example, certain applications may require a high pressure-capable hose, while other applications may require a hose that can withstand concentrated solvents or high temperatures. The modular and universal attachment means of the system permit components to be relocated throughout a facility as needed, and the system may be routinely customized by adding various components to the system.

With reference to FIG. 1, a modular rinse assembly typically includes the riser adapter 12, live swivel fitting 20, and flex hose 30 having threaded ends 31, 33. A spray nozzle adapter 13 may be present to allow a female flex hose end to be attached to the spray nozzle 40. An additional live swivel may be incorporated between the spray nozzle and the second end of the hose, for example as shown in FIG. 4.

Retrofit Method

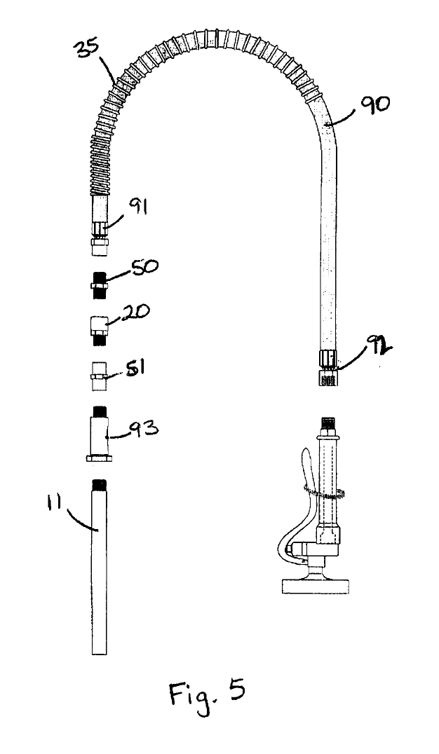

Despite the convenience of the aforementioned configuration, it is contemplated that users may wish to incorporate a swivel fitting at the base of their existing washdown system. With reference to FIG. 5, a retrofit system by which an existing pre-rinse system including a prior art flex hose 90 may be converted is provided. The prior art flex hose 90 typically bears female threaded ends 91, 92, for which compatible components are not readily available. As such, the present retrofit method provides a double-male adapter 50 to permit the existing flex hose to be attached to the live swivel fitting 20. The double-male adapter 50 is threaded on one side so as to be compatible with the first threaded end 91 of the existing flex hose 90. The second side of the double-male adapter is threaded so as to be compatible with the live swivel fitting. A double female fitting 51 is also similarly provided to make the live swivel fitting compatible with existing riser adapter 93. The retrofit components (double-female adapter, live swivel, and double-male adapter) may instead be provided as one live swivel fitting bearing a suitable female lower threaded end and a suitable male upper threaded end rather than three separate fittings. Many such variations are possible.

Retrofit Method with Dual Swivel

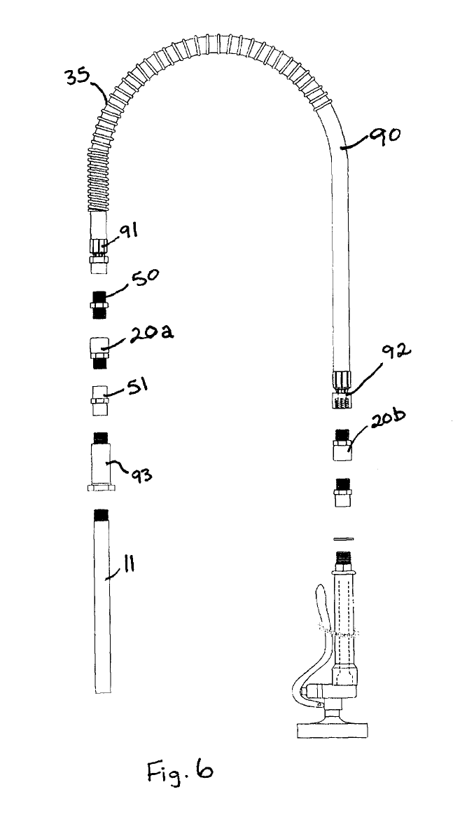

With reference to FIG. 6, a retrofit system is provided for incorporation of two live swivel fittings into an existing pre-rinse system. As in the system shown in FIG. 5, a double-male adapter 50 may be used to attach the flex hose to the first live swivel fitting 20a, and a double female fitting 51 is provided adapt the live swivel fitting for attachment to the riser adapter 93.

At the opposing end of the flex hose, a second live swivel fitting 20b is received by female threaded end 92. The live swivel is further attached to the spray nozzle using appropriate adapters.

Although inclusion of a single live swivel fitting 20a between the valve base and the first end 91 of the flex hose is suitable for relieving tension and shear stress applied to the flex hose, addition of a second live swivel fitting 20b reduces the torsion and shear stress at the source (the spray nozzle). This further reduces wear to the flex hose by limiting the amount of tension and shear stress applied to the flex hose, improving the overall mobility of the pre-rinse system.

Customized live swivel fittings may be manufactured or machined to minimize the number of fittings required.

Suitable Locations of Live Swivel

In certain embodiments, it may be sufficient to include a live swivel fitting only at the spray nozzle end of the flex hose or only at the valve base end of the flex hose. Suitable adapters may be purchased or manufactured to accommodate a live swivel fitting at any location along the pre-rinse system. Moreover, the owner or user may add or remove live swivel fittings at any location(s) along the pre-rinse system based on the desired degree of system flexibility required/desired. Particularly when standard threadings are used on all system components, fittings may be easily added, removed, or replaced.

Other modifications to fittings are also possible to simplify the system. For example, it is also possible to provide a live swivel fitting having a crimpable portion for attachment directly to the flex hose, such that the first end of the flex hose need not be threaded. Similarly, the spray hose adapter may bear a crimpable portion for attachment directly to the opposing end of the flex hose, such that the second end of the flex hose need not be threaded.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A rinse assembly for use in commercial washdown systems, the rinse assembly comprising:
a length of flexible hose having first and second hose ends, the first hose end operatively attachable to a valve base associated with a fluid source, the second end for handling and manipulation by a user in rinsing items; and
a live swivel fitting operatively attached to the first or second end of the flex hose for limiting torsion within the flex hose during use.

2. The rinse assembly as in claim 1, wherein the live swivel fitting is threadably attached between the first end of the flex hose and the valve base for relieving torsion within the flex hose during use.

3. The rinse assembly as in claim 2, further comprising a second live swivel fitting threadably attached between the second end of the flex hose and a spray nozzle for preventing application of torsion to the flex hose during manipulation of the spray nozzle.

4. The rinse assembly as in claim 1, wherein the live swivel fitting is threadably attached between the second end of the flex hose and a spray nozzle for preventing application of torsion to the flex hose during manipulation of the spray nozzle.

5. The rinse assembly as in claim 1, wherein the live swivel is rotatable through 360 degrees about the hose axis.

6. (canceled)

7. The rinse assembly as in claim 1, wherein the live swivel fitting is attached to an end of the flex hose by crimping a portion of the live swivel fitting over the end of the flex hose.

8. (canceled)

9. The rinse assembly as in claim 1, wherein the valve base comprises a tap assembly and a vertical riser.

10. The rinse assembly as in claim 1, wherein the rinse assembly is installed adjacent one or more wash stations and wherein the second end of the flex hose is used for rinsing items at said wash stations.

11. The rinse assembly as in claim 1, wherein the flexible hose is of a type suitable for use in high pressure applications.

12. The rinse assembly as in claim 1, wherein the flexible hose is of a type suitable for use in high temperature applications.

13. The rinse assembly as in claim 1, further comprising a ring coil for placement about the flex hose to support the flex hose.

14. The rinse assembly as in claim 13, wherein the ring coil extends over the live swivel fitting.

15. A method for retrofitting a commercial rinse assembly to incorporate a live swivel fitting, the method comprising the steps of:
providing a live swivel fitting, and
installing the live swivel within a rinse assembly.

16. The method as in claim 15, wherein the live swivel fitting bears suitable threaded ends for attachment to existing rinse assembly hardware.

17. The method as in claim 16, wherein the live swivel fitting has been produced by:
machining a standard male or female fitting to receive a bearing and a seal to produce an live swivel inner portion having a threaded end and a swivel extension end;
placing a bearing and seal about the swivel extension end of the live swivel inner portion; and
swaging a male fitting over the live swivel inner portion, the bearing, and the seal to produce a live swivel fitting.

18. The method as in claim 15, wherein the live swivel fitting is of suitable diameter to slidably receive a ring coil, and wherein the live swivel fitting is attached between a vertical riser and a first end of a flexible hose.

19. The method as in claim 15, further comprising the steps of:
providing an adapter fitting for attachment between the live swivel fitting and existing rinse assembly hardware; and
connecting the adapter fitting to the live swivel fitting.

20. (canceled)

21. The method as in claim 15, further comprising the step of installing a second live swivel fitting within the rinse assembly.

22. The method as in claim 18, wherein the live swivel fitting is installed at a second end of the flexible hose.

23. A modular rinse assembly in which components may be individually replaced with standard parts, the system comprising:
a threaded live swivel fitting for threadable association with a flex hose;
a threaded spray assembly for threadable association with a flex hose; and
a flex hose bearing a first threaded end for association with a valve base and a second threaded end for association with the spray nozzle,
wherein the threaded portion of each of the valve base, live swivel fitting, flex hose, and spray assembly are of standard pipe threading such that any damaged component may be individually replaced within the assembly by a standard threaded replacement component.
